(19) United States
(12) Patent Application Publication
(10) Pub. No.: US 2025/0165414 A1
(43) Pub. Date: May 22, 2025

(54) SYSTEM AND METHOD FOR ON-DEMAND SEPARATED I/O CHANNELS

(71) Applicant: CARNEGIE MELLON UNIVERSITY, Pittsburgh, PA (US)

(72) Inventors: Miao Yu, Pittsburgh, PA (US); Virgil Gilgor, Pittsburgh, PA (US)

(73) Assignee: CARNEGIE MELLON UNIVERSITY, Pittsburgh, PA (US)

(21) Appl. No.: 18/841,843

(22) PCT Filed: Mar. 7, 2023
(86) PCT No.: PCT/US23/14701

§ 371 Date: Aug. 27, 2024

Related U.S. Application Data
(60) Provisional application No. 63/319,864, filed on Mar. 15, 2022.

(51) Int. Cl. G06F 13/20

(52) U.S. Cl. CPC G06F 13/20; G06F 2213/40

(57) ABSTRACT

Disclosed herein is a system and method to provide secured I/O channels for multiple types of I/O devices to isolated applications, on-demand. The invention enables composition of different I/O kernels and, as such, eliminates developer effort required to re-implement and re-verify new I/O kernels to protect multiple types of I/O devices.

### CROSS REFERENCE TO RELATED APPLICATION

This application claims the benefit of and priority to, U.S. Provisional Patent Application No. 63/319,864, filed Mar. 15, 2022, entitled “System and Method for On Demand Separated I/O Channels,” which application is incorporated herein by reference in its entirety.

### BACKGROUND

The Input/Output (I/O) software of an operating system (OS) (e.g., Windows, Linux, MacOS, Android) and applications (Apps) executing under the OS are known to contain many undiscovered security flaws. As such, they cannot be trusted to maintain the I/O separation of isolated (i.e., secure) applications (referred to herein as “SecApps”). Thus, there is a need to provide SecApps with separate I/O channels to multiple types of devices, to allow the SecApps to securely interact with users, cyber-physical systems, and mission critical devices that connect to them.

Previous inventions disclose I/O kernels that establish separated I/O channels for SecApps on-demand. When SecApps need to communicate with their I/O devices, I/O kernels remove devices from untrusted OS and Apps on-demand and then separate and assign them to the SecApps. After the SecApp finishes using these devices, the I/O kernels relinquish them from the SecApp and return them to the untrusted OSes and Apps. The term “on-demand” applies only to the re-assignment of I/O devices and related hardware resources (e.g., memory, device I/O ports, and interrupts), and not always to the loading and execution of SecApps, I/O kernels, and other software components. For example, SecApps and I/O kernels may be initialized prior to an untrusted OS or App or may execute at the request of a user.

Previous I/O kernels allow a SecApp to exclusively own a device or securely share a device with untrusted OSes and Apps and other SecApps. For example, an I/O kernel called Wimpy Kernel, disclosed in U.S. Pat. No. 10,235,515, provides SecApps with exclusive accesses to their USB peripheral devices like a keyboard or a mouse. Another I/O kernel, the Graphic Processing Unit (GPU) separation Kernel (GSK), disclosed in U.S. Pat. No. 11,200,350, allows untrusted OSes and Apps and SecApps to access a GPU concurrently and to provide the SecApp with separated display windows. Both I/O kernels ensure I/O separation between untrusted OSes and Apps and SecApps, and between SecApps. In other words, I/O kernels protect the confidentiality and authenticity of a SecApp's I/O communications from all other software.

However, each prior art I/O kernel supports secure separation of only single types of devices. For example, the Wimpy Kernel provides separated I/O channels to USB devices only, whereas GPU Separation Kernel supports separation of displaying windows only. Currently, SecApps cannot use two or more different types of devices by executing multiple I/O kernels at the same time, because each kernel requires exclusive control over a subset of hardware resources (e.g., CPU registers, kernel stack, and interrupts) including the shared hardware access authorization components (e.g., IOMMU and PCIe Access Control Service (ACS)). As a result, I/O kernel developers currently must build different kernels for every combination of device types to support SecApps that require separated access to multiple types of devices with high assurance. This causes the development cost for high assurance to rise to the point of being impractical.

The composition of I/O kernels can support separated I/O channels of multiple types of devices and scale up to many types of devices. However, the composition must be secure in that it must maintain separated access to different types of devices. Also, it must be able to support I/O kernels for various types of devices, and be compatible with general commodity OSes, Apps, and hardware. Such a composition does not currently exist, even with a plurality of I/O kernels built on top of various systems, such as ARM TrustZone. Although these I/O kernels can use on-demand re-assignment of various of I/O devices between untrusted OS/Apps in non-secure spaces (e.g., the normal world in ARM TrustZone) and SecApps in secure spaces (e.g., the secure world in ARM TrustZone), these I/O kernels do not and cannot achieve secure composition for several reasons.

First, I/O bus controllers are not individual I/O devices, but a bus controller having all I/O devices connected to it. Thus, existing I/O kernels cannot preserve compatibility with untrusted commodity OSes and Apps while enforcing separated access. For example, U.S. Pat. No. 10,235,515 (Gligor, et al.) suggests that a USB host controller assigned to a SecApp may connect to both the SecApp's USB peripheral devices and to untrusted USB devices of the untrusted OS and Apps. Thus, the SecApp cannot reset all USB devices to allow OSes and Apps to continue using their USB devices after the SecApp exits. However, most I/O kernels (e.g., guest virtual machine OS kernels) either reset all USB devices or must include one or more USB device drivers to properly clean data of the SecApp in the USB devices of OSes and Apps, thereby decreasing assurance. That is, these I/O kernels are huge and complex, so their security properties become unverifiable. The Wimpy Kernel achieves both security and compatibility goals by exporting USB device drivers to the SecApp and resetting SecApp's devices. However, it only supports USB devices and not composition.

Second, secure spaces are not always more privileged than non-secure spaces regarding the non-secure space resources (e.g., ARM TrustZone). Without this security guarantee, I/O kernels implemented in secure spaces cannot support SecApps and untrusted OS and Apps to have secure concurrent accesses to a same I/O device (e.g., GPU and display). To allow concurrent accesses, untrusted device drivers must be redesigned to communicate with I/O kernels instead of the I/O device, and hence forgo compatibility with commodity operating systems.

Third, privileged secure spaces available on general hardware (e.g., CPU rings) do not implement on-demand I/O separation for multiple types of devices. Thus, I/O kernels either use special hardware and, as such, are incompatible with general commodity hardware, or have huge, trusted code bases and low security assurance (e.g., as in virtual machines), or are incompatible with commodity OSes and Apps (e.g., when micro-kernels are used).

### SUMMARY

Described herein is a system and method to provide on-demand, secured I/O channels for multiple types of I/O devices to SecApps. The invention enables composition of different I/O kernels and, as such, eliminates developer effort required to re-implement and re-verify new I/O kernels to protect multiple types of I/O devices.

The present invention supports general on-demand I/O kernels and is compatible with general commodity OSes, Apps and hardware. Central to the composition of I/O kernels is an on-demand I/O composition kernel (IOCK), an add-on trustworthy component isolated from the OS and Apps by an underlying Execution Environment Isolation (EE Isolation), an isolation mechanism for Isolated Execution Environments (IEEs). Unlike a trusted execution environment (TEE), IEEs need not always require trusted hardware modules (e.g., a Trusted Platform Module, or TPM) for root-of-trust establishment. Thus, EE Isolation can be implemented on a larger variety of hardware platforms while supporting code isolation.

As shown in FIG. 1, the IOCK 100 supports I/O separation modules 110-1 . . . 110-n (IOSMs), such that each IOSM 110 and the IOCK 100 implement the functions of an on-demand I/O separation kernel for an individual type of device. Furthermore, the IOCK 100 implements the secure composition of IOSMs 110-1 . . . 110-n. The IOCK 100 enforces access control to hardware resources (e.g., memory, device I/O ports, interrupts) and hardware access authorization components (e.g., IOMMU, PCIe Access Control Service), such that OS 120, Apps 122, SecApps 112-1 . . . 112-n and IOSMs 110-1 . . . 110-n cannot break the I/O separation properties offered by any IOSMs 110-1 . . . 110-n.

The IOCK 100 further implements several types of communications. FIG. 1 shows a non-limiting subset of them, including: communications between SecApps 112-1 . . . 112-n, and communications between SecApps 112-1 . . . 112-n and IOSMs 110-1 . . . 110-n. Thus, the IOCK 100 supports the secure composition of different I/O kernels and supports SecApps 112-1. 112-n that require multiple types of I/O devices.

The present invention can be embodied in different designs providing similar functions as the present invention. For example, in some embodiments, the EE Isolation, the IOCK 100, IOSMs 110-1 . . . 110-n, and/or SecApps 112-1 . . . 112-n include or can be embodied as computer-readable instructions, processor micro-code, firmware and/or hardware. In some other embodiments, the SecApps 112-1 . . . 112-n execute at either the OS kernel privilege level (e.g., Ring-0), at the user level (e.g., Ring-3), or at both levels.

### BRIEF DESCRIPTION OF THE DRAWINGS

By way of example, a specific exemplary embodiment of the disclosed system and method will now be described, with reference to the accompanying drawings, in which:

FIG. 1 is a block diagram providing an overview of the on-demand I/O separation for multiple types of devices. The gray boxes represent the trusted code of isolated SecApps and composed I/O kernels.

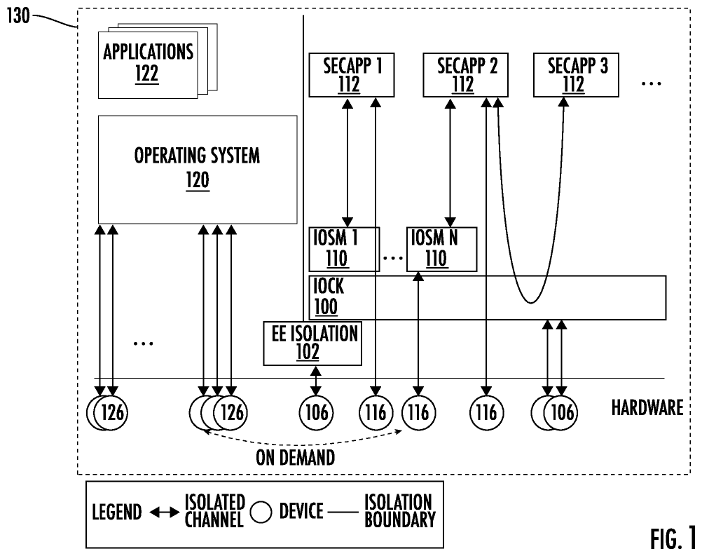

FIG. 2 is a block diagram showing one possible embodiment of the I/O composition kernel (IOCK). The gray boxes represent the trusted code of isolated SecApps and composed I/O kernels of FIG. 1.

FIG. 3 is a block diagram showing the architecture of the I/O composition kernel (IOCK) with deprivileged I/O separation modules (IOSMs).

FIG. 4 is a timing diagram for using the IOCK-1 on-demand.

FIG. 5 is a timing diagram for using an IOSM on-demand.

FIG. 6 is a timing diagram for using a SecApp on-demand.

FIG. 7 is a block diagram showing the architecture of an I/O composition kernel (IOCK) with embedded I/O separation modules (IOSMs).

### DETAILED DESCRIPTION

To provide context, the adversary model is first described, followed by a description of the functions of the I/O kernel composition.

The composition of I/O kernels preserves the existing capability of the I/O kernels to enforce I/O separation on-demand. The OS 120 manages all I/O devices excluding the I/O devices 106 of the I/O composition kernel (IOCK) 100 and Execution Environment Isolation (EE Isolation) 102 (e.g., Trusted Platform Modules) on the computing system 130, most of the time. When a SecApp 112 demands communications with one or more types of devices 116, the IOCK 100 executes corresponding I/O separation modules (IOSMs) 110, which take control of necessary devices 126 and hardware resources from the OS, verify their OS configurations if needed, and allocate them to the SecApp 112. After the SecApp 112 is done with its devices 116, it notifies the IOSMs 110 and/or the IOCK 100 to re-assign the I/O devices and all related hardware resources (e.g., memory, device I/O ports, interrupts, and hardware access authorization components (e.g., PCIe Access Control Service (ACS)) to the OS 120.

Requesting on-demand I/O separation does not imply that SecApps 112, IOSMs 110, IOCK 100, and EE Isolation 102 are loaded and execute on-demand. In some embodiments, a non-empty set of SecApps 112 and IOSMs 110 execute before OS 120 boots. However, SecApps 112, IOSMs 110, and IOCK 100 cannot use any I/O devices other than I/O devices 106 of IOCK 100 and EE Isolation 102 in all of these embodiments before OS 120 boots.

Adversary Model-The composition of I/O kernels follows the same adversary model of on-demand I/O separation. Thus, an adversary could compromise the OS 120 and Apps 122, and control any of their hardware resources (e.g., memory, device I/O ports, interrupts, and hardware access authorization components). The compromised OS 120 and Apps 122 can directly attack the IOCK 100, the EE Isolation 102, IOSMs 110, and SecApps 112. The compromised OS 120 and Apps 122 can also intentionally mis-configure their I/O devices 126, including the I/O devices that it hands over to SecApps 112 and IOSMs 110, on demand. Mis-configured I/O devices may then unwittingly perform arbitrary operations to breach the isolation of a SecApp 122, such as by issuing Direct Memory Access (DMA) requests to SecApps 112 and IOSMs 110 and issuing I/O device peer-to-peer (p2p) accesses to their I/O devices. In addition, a malicious SecApp 112 or IOSM 110 may attempt to compromise the IOCK 100, the EE Isolation 102, other IOSMs 110, and/or other SecApps 112 by manipulating their interfaces or mis-configuring I/O devices 116.

The composition of I/O kernels must be secure, able to support I/O kernels for various types of I/O devices, and compatible with general commodity OSes 120, Apps 122 and hardware. Thus, the composition of I/O kernels must achieve three functions.

First, the composition of I/O kernels must be able to enforce I/O separation for each type of I/O device and multiple types of devices. If unable to enforce I/O separation for each type of I/O device, the composition fails. In this case, I/O kernel developers have to re-implement kernels for each set of I/O devices types, and, hence, the overall development effort is significant. In other words, this function is necessary in reusing existing I/O kernels. If unable to enforce I/O separation for multiple types of devices, the composition fails to secure SecApps 112 that require multiple types of I/O device.

Second, the composition of I/O kernels must enable formal verification (i.e., proving the security properties informally described in the first function). This requires the composition to have a small and simple design and implementation and to support general I/O kernels. A strawman approach of composing I/O kernels into a new monolithic OS 120 does not work. Though supporting general I/O kernels, the approach yields bulky and complex code, and hence forbids formal verification.

Third, the composition of I/O kernels maintains compatibility with general OSes 120, Apps 122 and hardware. To be compatible with software, the kernel composition must not require re-design or re-compilation to OSes 120 or Apps 122. Furthermore, the kernel composition must also not break the accesses of OSes or Apps to their hardware resources.

### I/O System Design

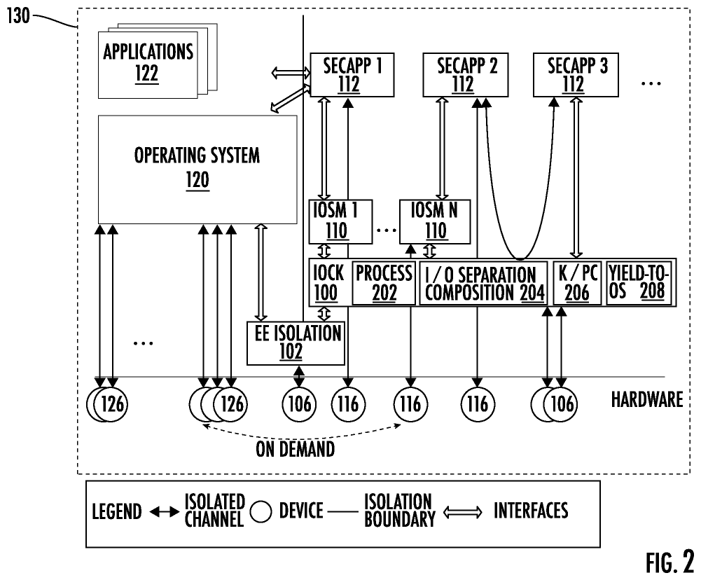

To fulfill all three functions of composition of I/O kernels, an add-on security architecture is defined to compose the I/O composition kernel (IOCK) 100, the EE Isolation 102, I/O separation modules (IOSMs) 110, and SecApps 112. The system is illustrated in an embodiment of the system architecture shown in FIG. 2. Note that different embodiments of the present invention are possible. For example, adding communication channels between Apps 122 and IOSMs 110, running SecApps at OS kernel privilege, and/or implementing a subset of the IOCK's components into a new or another software or hardware component.

The present invention can include or be embodied as computer-readable instructions, processor micro-code, firmware, hardware, and other embodiments which, when executed, causes the processor to perform certain actions according to the present invention.

Platform-The present invention includes a computing system 130, shown in FIG. 2, that includes: one or more processors (CPUs, not shown), each including one or more CPU cores, memory (not shown) connected to the CPU cores and one or more I/O devices 126, 106, and 116. Multiple I/O devices are connected to system 130 via chipset hardware and/or bus controllers.

In one non-limiting example, USB devices are connected to a USB bus controller, and the USB bus controller is connected to the southbridge, which is connected to the CPU cores and memory via northbridge and memory controller. I/O devices are in communication with at least one of the CPU cores. The IOCK 100 owns a subset of I/O devices 106 (e.g., Trusted Platform Modules). OSes 120 and Apps 122 assign a subset of the rest of I/O devices 126 to be SecApps devices 116 on-demand.

System 130 further includes computer-readable instructions stored for execution by a processor. As used herein, the term “processor” should be interpreted to include processors, one or more CPU cores of the processors, chipsets, I/O devices, computer memory, and/or their firmware. The computer-readable instructions, when executed by a processor, cause the creation of an I/O kernel composition system, including: one or more OSes 120, which may run one or more Apps 122 on top of the OSes 120, an Execution Environment Isolation (EE Isolation) 102 that creates, manages, and destroys secure domains, an I/O Composition Kernel (IOCK) 100, one or more I/O Separation Modules (IOSMs) 110 and one or more isolated applications (SecApps) 112. Each component will now be explained.

Operating Systems—The OSes 120 may run one or more Apps 122. OSes 120 can be commodity OSes (e.g., Windows, Linux, MacOS, Android) or special-purposed OSes (e.g., hardened OS, security kernels) for bare-metal or virtualized environments, executing on, for example, computers, real-time systems, embedded systems and mobile phones etc. Note that some embodiments add loadable kernel modules into the OSes 120, to facilitate on-demand I/O separation etc. These modules are included in the OSes 120.

Execution Environment Isolation—An Execution Environment Isolation (EE Isolation) 102 creates, manages, and destroys domains for the OS(es) 120 and Apps 122 (i.e., “untrusted domains”). Each untrusted domain includes a subset of, and not limited to: CPU contents, exclusively owned regions of memory. Consequently, each domain occupies separated regions of the memory of system 130 (i.e., “machine memory”), defines its own physical memory (i.e., “domain physical memory”) on top of the machine memory, and is separated from EE Isolation 102 and its devices 106. Further, each untrusted domain may be assigned devices 126 of OS 120 and Apps 122.

EE Isolation 102 may further create secure domains for the IOSMs 110 and the SecApps 112 (i.e., “secure domains”). The EE Isolation 102 isolates between the secure domains and further isolates them from untrusted domains. Each secure domain may map the IOCK 100, IOSMs 110, and SecApps 112. Each secure domain is assigned with zero or more devices 106 for the IOCKs 100 and devices 116 for the IOSMs 110 and SecApps 122.

In some embodiments, EE Isolation 102 does not create any secure domains if EE Isolation 102 includes the IOCK 100, IOSMs 110 and SecApps 112 inside it. In some other embodiments, EE Isolation 102 includes only the IOCK 100, and creates secure domains for IOSMs 110 and SecApps 112. In some other embodiments, EE Isolation 102 creates secure domains on-demand after the OS(es) 120 boot. Other embodiments may implement EE Isolation 102 in the form of, but not limited to, a secure kernel, a micro-hypervisor or a hypervisor. Some other embodiments may include multiple instances of IOCK 100, and, as such, may require IOCK 100 to secure shared hardware resources between these instances.

EE Isolation 102 optionally relies on a hardware access authorization mechanism (e.g., IOMMU) to enforce memory separation properties between isolated domains. The properties include, but are not limited to, which domain may access which memory region(s) and devices and which device may perform direct memory access operations to which memory region(s). Furthermore, EE Isolation 102 optionally relies on root-of-trust hardware (e.g., Trusted Platform Module (TPM)) to further enhance the security of the computing system 130. In some embodiments, EE Isolation 102 may use two primitives of the TPM: sealed storage and attestation root-of-trust. Sealed storage allows users to bind certain data with the identity of a secure domain or domains, while attestation enables users to measure the identity of their domain and report the measured identity to an external third party or a trusted verifier device for verification.

EE Isolation 102 may provide interfaces to domains. In some embodiments, these interfaces allow switching domains on the same CPU core on-demand. In some other embodiments, the untrusted domains can use additional interfaces to register and unregister the secure domains on-demand. In some other embodiments, EE Isolation 102 does not provide any interfaces if the configurations of all domains do not change over time.

EE Isolation 102 optionally supports the IOCK 100 to intercept hardware resource accesses issued by any domains. Furthermore, EE Isolation 102 may support secure domains to intercept hardware resource accesses issued by untrusted domains.

I/O Composition Kernel—The I/O Composition Kernel (IOCK) 100 is isolated from the OS(es) 120 and Apps 122. IOCK 100 is further optionally isolated from IOSMs 110 and/or SecApps 112. IOCK 100 authorizes all accesses to hardware resources, including hardware access authorization components (e.g., IOMMU) issued by the OS(es) 120 and Apps 122. In some embodiments, IOCK 100 configures hardware access authorization components (e.g., IOMMU) to authorize a subset of these accesses. IOCK 100 further optionally authorizes a subset of accesses to hardware resources issued by IOSMs 110 and/or SecApps 112. In some embodiments, IOCK 100 does not perform this authorization if IOCK 100 trusts IOSMs 110 and/or SecApps 112.

IOCK 100 includes four components to separate hardware resources: Processes component 202, I/O Separation Composition component 204, Kernel/Process Communications (K/PC) component 206, and Yield-To-OS component 208. IOCK 100 exposes one or more interfaces of these components to OS(es) 120, Apps 122, SecApps 112 and IOSMs 110. In some embodiments, the OS(es) 120 call IOCK 100 to create a SecApp 112. In other embodiments, a SecApp 112 calls IOCK 100 to communicate with another SecApp 112.

IOCK 100 optionally includes Processes component 202 to manage secure processes (“SecProcesses”) of SecApps 112 and IOSMs 110. The management includes, but is not limited to, storing information about SecProcesses, which is similar to storing process descriptors (a.k.a. “Process Control Blocks”) in an OS 120. Note that the notion of SecProcesses in the present invention only captures the characteristics of execution units of SecApps 112 and IOSMs 110 but does not require SecApps 112 and IOSMs 110 to run in any specific privilege level (e.g., Ring-3 of x86 CPUs). In some embodiments, Process component 202 provides more functions (e.g., SecProcess creation, termination, and switch to another SecProcess). Some other embodiments may not include this component if IOCK 100 only runs one SecApp 112 before IOCK 100 exits. In some embodiments, Process component 202 defines two types of SecProcesses: trusted and untrusted. In these embodiments, the I/O Separation Composition component 204 may allow only one trusted SecProcess to access IOMMUs (and equivalent functions) beyond IOCK 100, to simplify IOMMU management functions in IOCK 100.

The I/O Separation Composition component 204 authorizes SecProcesses, OS 120, and Apps 122 to access hardware resources (e.g., memory regions, device I/O ports, interrupts, and hardware access authorization components (e.g., IOMMUs, PCIe ACS), and may enforces access control policies that are required by the composition of I/O separation for multiple types of devices, such that none of these accesses can break the I/O separation for each type of device. Thus, the hardware resources include not only those accessible from secure domains, but also those accessible from the untrusted domains.

Different embodiments enforce different access control policies in this component. In some embodiments, the policies include a subset of, but are not limited to (a) hardware resource isolation between SecProcesses; and (b) only one trusted SecProcess may access IOMMUs (and equivalent functions) and similar hardware components (e.g., ACS and PCIe configuration space) that are relied on by I/O kernels, and the SecProcess must be securely shared. In other embodiments, I/O Separation Component 204 does not enforce any policies, if the memory separation properties enforced by EE Isolation 102 are sufficient for I/O separation on the corresponding hardware.

The Kernel/Process Communications (K/PC) component 206 processes communications related to the IOCK 100 and SecProcesses. These communications include a subset of, but not limited to: OS-IOCK communications, inter-SecProcess communications, and signals/interrupt delivery to SecProcesses. This component provides operations including a subset of, but not limited to: channel creation, channel destruction, and send/receive messages. Different embodiments may implement this component with different approaches. In some embodiments, the IOCK 100 allocates shared memory and initializes communications on top of them. In some other embodiments, the OS 120 may allocate shared memory and then instruct the IOCK 100 to initialize the OS-IOCK communications.

The IOCK 100 optionally includes Yield-To-OS component 208 to preserve the compatibility with OS 120 and Apps 122. Because the secure domains preempt the execution of untrusted domains on one or more CPU cores, the OS 120 and Apps 122 may not be able to timely handle their interrupts or reset watchdog timers and may crash as a result. In some embodiments, this component checks all interrupts received by the IOCK 100, and switches to OS 120 and Apps 122 on their interrupts. In some other embodiments, this component also checks all configurations of hardware watchdogs used by OS 120 and Apps 122 and pause them during the execution of the IOCK 100. In some embodiments, IOCK 100 does not include this component as long as it can preserve the compatibility with OS 120 and Apps 122.

IOCK 100 may also include one or more components common in other OS kernels (e.g., commodity OS kernels, separation kernels, and micro-kernels). For example, some embodiments implement CPU and MMU initialization code in IOCK 100, whereas some other embodiments implement them in the EE Isolation. In another example, IOCK 100 may include a time component, which allows SecApps 112 and IOSMs 100 to query the current time and perform delay operations correctly.

Note that some embodiments implement a subset of IOCK 100 (e.g., one or more components of IOCK 100, a subset of one component of IOCK 100, or multiple subsets of multiple components of IOCK 100) outside of IOCK 100. For example, some embodiments implement a subset of the I/O Separation Composition component 204 into one or more I/O Separation Modules (IOSMs) 110. Other embodiments may implement a subset of IOCK 100 in EE Isolation 102.

I/O Separation Modules-The IOSMs 110 are SecProcesses that service other SecProcesses (i.e., background processes). Unlike SecApps 112, IOSMs 110 are not scheduled unless they have pending requests to finish. These requests can be issued by OS 120, Apps 122, IOCK 100, EE Isolation 102, any IOSM 110, and any SecApp 112. In some embodiments, a subset of IOSMs 110 is implemented in the EE Isolation 102, IOCK 100 and/or SecApps 112.

One or more IOSMs 110 enforce I/O separation for individual types of devices. Each of IOSMs 110 enforces I/O separation for one or more types of devices. In some embodiments, one IOSM 110 may be a deprivileged Wimpy Kernel (“IOSM-USB2”). In some embodiments, one IOSM 110 allows multiple SecApps 112, OS 120 and Apps 122 to securely share the same I/O device (e.g., the deprivileged GPU Separation Kernel). Some other embodiments include additional IOSMs 110 that enable composition of the IOSMs 110. For example, these embodiments may implement a subset of I/O Separation Composition component 204 into IOSMs 110. In some other embodiments, the IOSMs 110 enabling composition may also include an INIT IOSM which only schedules SecProcesses. Some other embodiments implement these additional IOSMs 110 in other IOSMs 110, SecApps 112, IOCK 100 and/or the EE Isolation 102.

To function correctly, IOSMs 110 can invoke IOCK 100 to gain accesses to zero or more devices each. For example, IOSM-USB2 can access multiple devices, including USB2 host controllers and multiple USB peripheral devices. And the INIT IOSM does not need to access any devices at all.

Secure Applications-Each SecApp 112 may require I/O communication to multiple types of I/O devices, and, as such, invoke IOCK 100 and/or IOSMs 120 to gain accesses to the I/O devices. Some embodiments aim to provide OS 120 and Apps 122 with I/O separation, and hence do not run any SecApps 112. In some other embodiments, a SecApp 112 directly communicates with its PCIe devices without invoking any IOSMs 110 after the IOSM 110 sets up I/O separation of these devices (see the SecApp 2 in FIG. 2). Note that the present invention also supports SecApps 112 that do not use any I/O devices and SecApps 112 that use only one type of I/O device. In some embodiments, a subset of SecApps 112 is implemented in EE Isolation 102, IOCK 100 and/or IOSMs 110.

Setting Up and Tearing Down I/O Channels-Whenever a SecApp 112 demands separated I/O channels to its I/O devices, system 130 of the present invention executes a series of steps, including but not limited to, and not limited to the following order:
(1) The OS 120 or Apps 122 may configure one or more I/O devices for use by a SecApp 112 and assign these I/O devices to IOCK 100. For example, the OS 120 or Apps 122 may pause the I/O devices. Note that OS 120 or Apps 122 may not need to configure any I/O devices if the I/O devices needed by the SecApp 112 have already be assigned to IOCK 100 or the IOSMs.
(2) IOCK 100 may assign a subset of these devices (e.g., bus controllers) to one or more IOSMs 110 and execute those IOSMs 110. Note that no IOSMs 110 will be needed if no new devices are assigned to IOCK 100.
(3) IOSMs 110 provide separated I/O channels of a subset of these I/O devices (e.g., peripheral devices) to the SecApp 112.

Note that on-demand I/O separation allows some embodiments to initialize IOCK 100 and the IOSMs 110 prior to booting OS 120. In these embodiments, the OS 120 and/or Apps 122 manage all I/O devices except the devices of IOCK 100 and EE Isolation 102 most of the time and assign their I/O devices to the IOSMs 110 and SecApps 112 when needed. In some other embodiments, the EE Isolation 102 initializes IOCK 100 on-demand, and IOCK 100 initializes the IOSMs 110 on-demand.

Once set up the separated I/O channels, system 130 of the present invention ensures that the I/O communications between a SecApp 112 and its I/O devices cannot be intercepted or modified by OS 120, Apps 122, other SecApps 112, or by their associated I/O devices.

To tear down I/O channels, IOSMs 100 finalize the I/O channels of SecApps 112. Furthermore, an IOSM 110 may invoke IOCK 100 to release its control over an I/O device. IOCK 100 may invoke the EE Isolation 102 to re-assign the hardware resources of the I/O device to the OS 120 or Apps 122. Then, OS 120 or Apps 122 optionally configure the I/O device for use (e.g., the OS 120 or Apps 122 may resume the execution of the I/O device).

Some embodiments may perform additional steps, and/or change the orders of the steps. For example, in some embodiments, the IOSMs 110 may check configurations of a subset of I/O devices performed by the OS 120 before assigning devices to SecApps 112.

### Best Mode of Implementation

The present invention will now be described in terms of three specific embodiments for x86 hardware. These embodiments are only illustrative of the present invention. However, the present invention is not limited to these specific embodiments and other embodiments are possible.

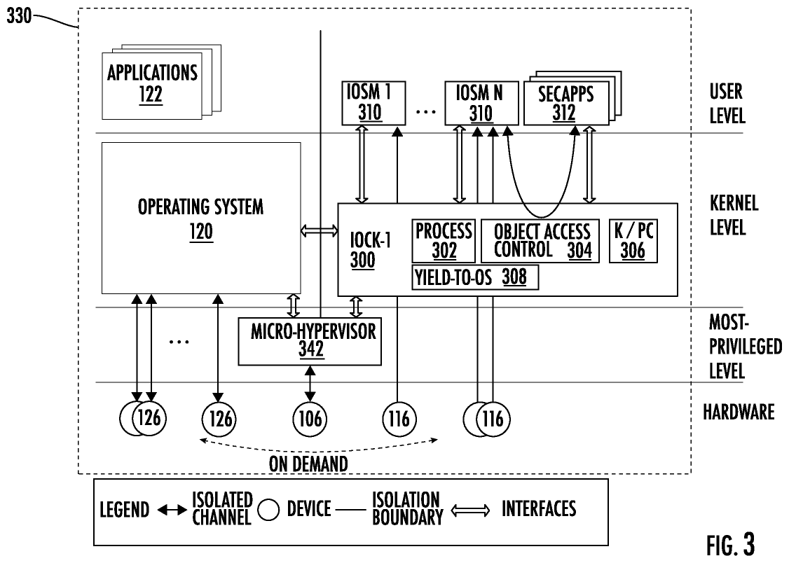

First Exemplary Embodiment—IOCK with Deprivileged IOSMs—FIG. 3 shows an x86 computer 330 with one implementation of the present invention. Three devices 126 are assigned to the secure domain on-demand.

In this embodiment, EE Isolation 102 is implemented into a micro-hypervisor (mHV) 342. Micro-hypervisor 342 runs at the most-privileged level (a.k.a. Ring-1) of the x86 hardware. It creates one untrusted domain to run OS 120 and Apps 122. Then it creates one secure domain on-demand when users need to run any SecApp 112. Micro-hypervisor 342 fulfills all the required properties of EE Isolation 102 listed in the previous section and enforces memory separation between the two domains. Micro-hypervisor 342 provides interfaces to the untrusted domains (e.g., for registration and un-registration of the secure domain on-demand). Micro-hypervisor 342 also provides interfaces to the secure domains, for ensuring that the configuration of IOMMU by the secure domains does not break the memory security properties (e.g., micro-hypervisor's memory integrity) enforced by the micro-hypervisor 342.

In this embodiment, IOCK-1 300 implements a subset of components of IOCK 100. IOCK-1 300 executes on and is assigned to one of the CPU cores. IOCK-1 300 executes at the kernel level (a.k.a. Ring-0) and executes all IOSMs 310 and SecApps 312 at the user level (a.k.a. Ring-3).

The Process component 302 implements the Process component 202 described in the previous section. The component 302 defines trusted and untrusted SecProcesses. The context of the SecProcesses defined by Process component 302 includes specific programming interfaces and data structures of x86 hardware (e.g., general purpose CPU registers, 32-bit x86 page tables, and stack layout for interrupts and CPU exceptions).

Object Access Control component 304 implements a subset of the I/O Separation Composition component 204 described in the previous section. The component 304 authorizes accesses to hardware resources by SecProcesses and OS/Apps. These resources include the secure domain's physical memory space, the computer 330's machine memory space, I/O device ports, interrupts, IOMMUs, and I/O ports to access PCIe configuration space. This embodiment implements the Object Access Control component 304 with capabilities system. That is, each SecProcess is associated with a record of accessible objects and its permissions.

The Kernel/Process Communications (K/PC) component 306 implements the K/PC component 206 described in the previous section, and processes communications related to IOCK-1 300 and SecProcesses. In this embodiment, IOCK-1 300 defines four types of communication channels: OS-IOCK communications, inter-SecProcess communications, signals/interrupt delivery to SecProcesses, and mHV-SecProcess communications. The OS-IOCK communications allows OS 120 to exchange information with IOCK-1 300 without switching domains on multi-core systems, similar to the TK-OS communication channel described in U.S. Pat. No. 10,235,551. The inter-SecProcess communications is necessary for SecApps 312 to invoke IOSMs 310 for I/O separation. The signals/interrupt delivery to SecProcesses is necessary for the device interrupt handling of IOSMs 310 and SecApps 312 and SecProcess debugging. The mHV-SecProcess communications is necessary for the deprivileged GPU Separation Kernel (GSK) described in U.S. Pat. No. 10,769,312. That is, the deprivileged I/O kernel must be able to authorize OS 120 and Apps 122 to accesses to physical GPU devices.

The Yield-To-OS component 308 is necessary because the OS 120 (e.g., Linux) crashes if it does not receive interrupts from its I/O devices for a preset time interval. Thus, the Yield-To-OS component 308 checks all interrupts received by IOCK-1 300. If the interrupt is not for IOCK-1 300 or any IOSMs 330 or any SecApps 312, then the Yield-To-OS component 308 invokes the micro-hypervisor 342 to switch to the untrusted domain with the interrupt injected to this domain.

This embodiment executes four processes of user-level I/O Separation Modules (IOSMs) 310.

IOSM-USB2 provides on-demand I/O separation for USB2 devices. The USB2 devices include one or more USB2 host controller devices connected to PCIe buses. IOSM-USB2 is a deprivileged Wimpy Kernel.

IOSM-FB provides on-demand I/O separation for framebuffers and displays and allows SecApps 312 and OS 120 or Apps 122 to display in separated windows at the same time. The framebuffers and displays include one or more GPUs connected to PCIe buses. IOSM-FB has a similar design with the GPU Separation Kernel (GSK) described in U.S. Pat. No. 10,769,312, but with a simpler framebuffer and display devices.

IOSM-PCIE supports the composition of IOSM-USB2 and IOSM-FB, and, as such, implements a subset of the I/O Separation Composition component 204. IOSM-PCIE provides both modules with exclusive accesses to their PCIe devices. Further, it authorizes configurations of the IOMMU and PCIE Access Control Service (ACS) performed by both modules. Whenever updating IOMMU and PCIE ACS is needed, IOSM-USB2 and IOSM-FB invoke IOSM-PCIE via inter-SecProcess communication channels to write the new configurations.

INIT provides process management and scheduling.

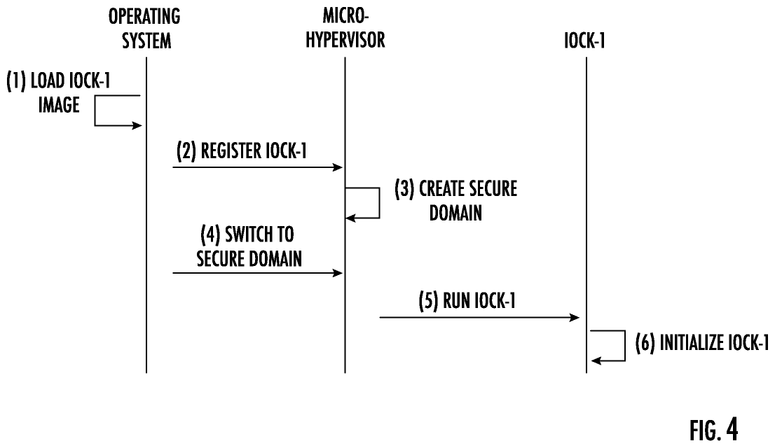

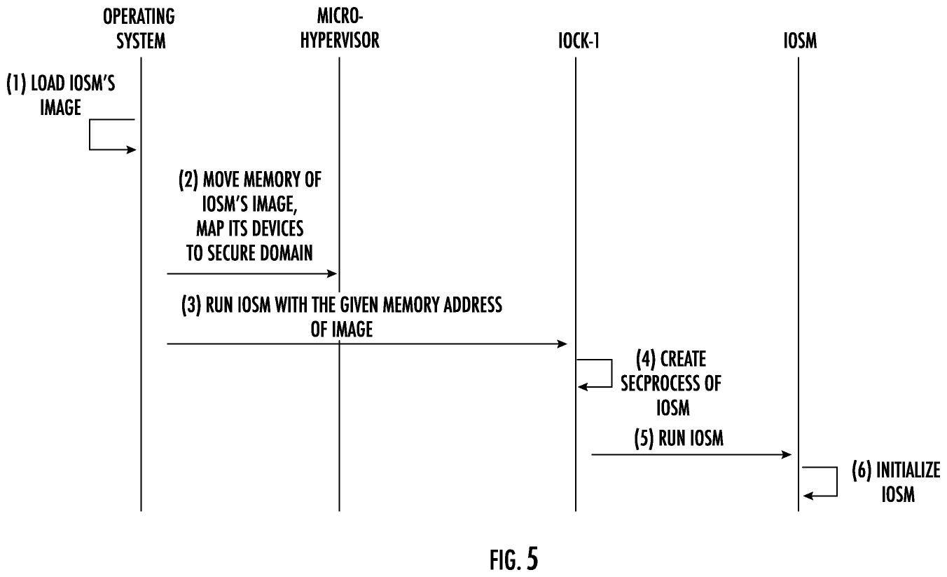

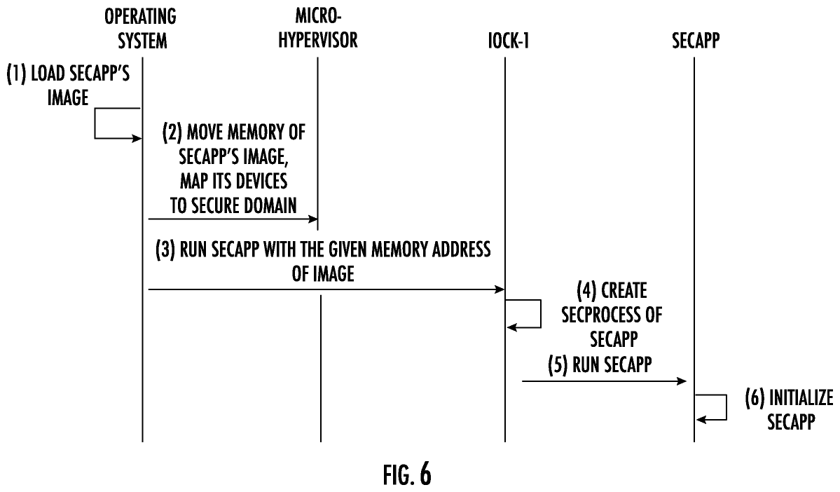

In this embodiment, SecApps 312 implement SecApps 112 and includes device drivers, which invoke IOSM-USB2 and IOSM-FB to access corresponding devices. When users run a SecApp 312, users need to run and initialize the IOCK-1 300 first if it is not already running (See FIG. 4), then the users need to run and initialize each of the related IOSMs 310 if they are not running (See FIG. 5), then the users need to run and initialize the SecApp 312 (See FIG. 6).

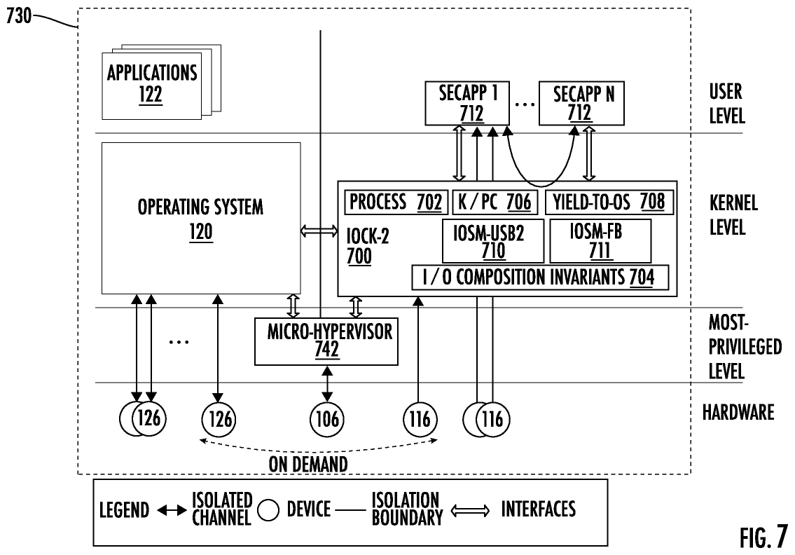

Second Exemplary Embodiment—IOCK with Embedded IOSMs—FIG. 7 shows an x86 computer 730 running IOCK with embedded IOSMs. Three devices 126 are assigned to the secure domain on-demand.

In this embodiment, the micro-hypervisor 742 is similar to the micro-hypervisor 342. Process component 702 is similar to Process component 302. K/PC component 706 is similar to K/PC component 306. Yield-To-OS component 708 is similar to Yield-To-OS component 308. SecApps 712 are similar to SecApps 312.

This embodiment includes two IOSMs in the IOCK-2 700: IOSM-USB2 710 and IOSM-FB 711. IOSM-USB2 710 provides on-demand I/O separation for USB2 devices and is similar to the corresponding IOSM 310. IOSM-FB 711 provides on-demand I/O separation for framebuffers and displays and is similar to the corresponding IOSM 310. There are two differences from IOSM 310. First, IOSM-USB2 710 and IOSM-FB 711 execute at the kernel level, not the user level. Second, there is no IOSM-PCIE or INIT in this embodiment.

The I/O Composition Invariants component 704 implements a subset of the I/O Separation Composition component 204 described in the previous section. The component 704 authorizes SecApps 712, IOSMs 710 and 711, OS 120, and Apps 122 accesses to hardware resources (e.g., memory regions, device I/O ports, interrupts, and hardware access authorization components (e.g., IOMMUs, PCIe ACS) to preserve I/O separation for USB devices and framebuffer devices. The component enforces multiple access control policies, including secure sharing of IOMMUs and PCIe ACS and secure sharing of CPU registers and IOCK's kernel stack(s).

Third Exemplary Embodiment—IOCK in the EE Isolation—This embodiment implements the IOCK 100 in EE Isolation component 102. That is, EE Isolation 102 component includes IOCK 100. This embodiment optionally implements a subset of SecApps 112 and IOSMs 110 in the IOCK 100 and/or EE Isolation 102. The disadvantage of this embodiment is that it reduces the assurance of IOCK 100 and/or EE Isolation 102, because they are more complex to verify.

As would be realized by one of skill in the art, the disclosed method described herein can be implemented by a system comprising a processor and memory, storing software or firmware that, when executed by the processor, performs the functions comprising the method.

As would further be realized by one of skill in the art, many variations on implementations discussed herein which fall within the scope of the invention are possible. Moreover, it is to be understood that the features of the various embodiments described herein were not mutually exclusive and can exist in various combinations and permutations, even if such combinations or permutations were not made express herein, without departing from the spirit and scope of the invention. Accordingly, the method and apparatus disclosed herein are not to be taken as limitations on the invention but as an illustration thereof. The scope of the invention is defined by the claims which follow.

1. A system for providing on-demand, secured I/O channels between multiple types of I/O devices and one or more isolated applications comprising:
one or more processors;
one or more input/output devices in communication with at least one of the processors;
memory, connected to the one or more processors; and
computer-readable instructions, which when executed by the one or more processors cause the creation of an environment executing on the processor, comprising:
one or more operating systems;
an execution environment isolation component;
an I/O composition kernel component;
one or more I/O separation modules; and
one or more of the isolated applications;
wherein the environment creates the secured I/O channels.

2. The system of claim 1 wherein the environment further comprises:
one or more untrusted applications executing on top of the one or more operating systems.

3. The system of claim 1 wherein the isolated applications execute on top of the I/O composition kernel component, in the I/O composition kernel component, in the execution environment isolation component, or in one or more of the I/O separation modules.

4. The system of claim 1 wherein the I/O separation modules execute on top of the I/O composition kernel component, in the I/O composition kernel component, in the execution environment isolation component, or in one or more of the isolated applications.

5. The system of claim 1 wherein the execution environment isolation component creates one or more domains, each domain including a subset of:
processor contents; and
one or more regions of memory reserved for exclusive use of a secure domain.

6. The system of claim 4 wherein the execution environment isolation component partitions the memory into a plurality of domains separated from the execution environment isolation component and any I/O devices associated therewith, the plurality of domains including:
one or more secure domains for the exclusive use of the I/O composition kernel component, the I/O separation modules, the isolated applications, and any associated I/O devices; and
one or more untrusted domains for the exclusive use of the operating systems, any untrusted applications, and any associated I/O devices.

7. The system of claim 6 wherein the execution environment isolation component provides interfaces to secure domains and untrusted domains.

8. The system of claim 6 wherein the execution environment isolation further supports the I/O composition kernel component to intercept hardware resource accesses issued by any domains.

9. The system of claim 6 wherein the execution environment isolation further supports secure domains to intercept hardware resource accesses issued by untrusted domains.

10. The system of claim 6 wherein the execution environment isolation component performs the functions of:
creating one or more secure domains;
mapping the I/O composition kernel component, the isolated applications and the I/O separation modules to the one or more secure domains; and
assigning I/O devices required by the I/O composition kernel component, the isolated applications and the I/O separation modules to the one or more secure domains.

11. The system of claim 10 wherein the execution environment isolation component performs the further functions of:
creating one or more untrusted domains;
mapping the operating systems and the untrusted applications to the one or more untrusted domains; and
assigning I/O devices required by the operating systems or the untrusted applications to the one or more untrusted domains.

12. The system of claim 6 wherein the execution environment isolation component employs a plurality of security primitives to:
control which of the domains can access which memory regions;
control which of the domains can access which I/O devices; and
control which of the I/O devices can perform direct memory access operations to which memory regions.

13. The system of claim 2 wherein the I/O composition kernel component is isolated from the operating systems and the untrusted applications.

14. The system of claim 13 wherein the I/O composition kernel component authorizes all accesses for I/O devices issued by the operating systems and the untrusted applications.

15. The system of claim 14 wherein the I/O composition kernel component comprises:
an I/O separation composition component for authorizing accesses to hardware resources by the secure processes, the operating systems and the untrusted applications; and
a kernel/process communications component for processing communications related to the I/O composition kernel component and the secure processes.

16. The system of claim 15 wherein the communications include OS-IOCK communications, inter-secure process communications, and delivery of signals and interrupts to secure processes.

17. The system of claim 15, the I/O composition kernel further comprising:
a processes component for managing the secure processes of the isolated applications and the I/O separation modules.

18. The system of claim 17 wherein the managing includes storing information about the secure processes.

19. The system of claim 15, the I/O composition kernel further comprising a yield-to-OS component for preserving compatibility with the operating systems and the untrusted applications due to preempting the execution of the untrusted applications on the processors.

20. The system of claim 2 wherein the I/O separation modules are scheduled when there are pending requests issued by the operating systems, the untrusted applications, the I/O composition kernel component, the execution environment isolation component, the I/O separation modules, or the isolated applications.

21. The system of claim 2 wherein each of the I/O separation modules can invoke the I/O composition kernel component to gain accesses to the I/O devices.

22. The system of claim 2 wherein the I/O separation modules enforce I/O separation for one or more types of I/O devices.

23. The system of claim 2 wherein each of the isolated applications requires I/O communications to one or more types of the I/O devices and invokes the I/O composition kernel component and/or the I/O separation modules to gain accesses to the I/O devices.

24. The system of claim 2 wherein the I/O devices are assigned to secured I/O channels whenever an isolated application is executing, the assigning comprising:
one or more of the operating systems and/or one or more of the untrusted applications configure one or more I/O devices for use by an isolated application and assign the devices to the I/O composition kernel component;
the I/O composition kernel component assigns a subset of the I/O devices to one or more of I/O separation modules, and executes the one or more I/O separation modules; and
the I/O separation modules provide secure I/O channels for a subset of the I/O devices to the isolated application.

25. The system of claim 24 wherein I/O communications between the isolated application and the I/O device cannot be intercepted or modified by the operating systems, the untrusted applications, other isolated applications or associated I/O devices.

26. The system of claim 2 wherein the I/O devices assigned to secured I/O channels are re-assigned to the operating systems and/or the untrusted applications when no I/O separation module or isolated application has further need of the I/O device, the re-assigning comprising:
the I/O composition kernel component releases control of the I/O device by I/O separation modules and the isolated application; and
the I/O composition kernel component invokes the execution environment isolation component to re-assign hardware resources of the I/O device to an untrusted domain.

27. The system of claim 1 wherein a portion of the I/O composition kernel may be included inside or outside of the execution environment isolation component.

28. A method comprising:
loading an I/O composition kernel component image;
registering the I/O composition kernel component image with a micro-hypervisor;
creating a secure domain;
switching operation of the micro-hypervisor to the secure domain;
executing the I/O composition kernel component image in the secure domain; and
initializing the execution of I/O composition kernel component.

29. The method of claim 28 further comprising:
loading an I/O separation module image into memory;
moving the I/O separation module image to a secure domain;
mapping devices associated with the I/O separation module image to the secure domain;
invoking the I/O composition kernel to start the I/O separation module;
creating one or more secure processes of the I/O separation module image;
executing the I/O separation module image; and
initializing the executing I/O separation module.

30. The method of claim 29 further comprising:
loading an isolated application image into memory;
moving the isolated application image to a secure domain;
invoking the I/O composition kernel to start the isolated application;
creating secure processes of the isolated application;
executing the isolated application image; and
initializing the executing isolated application.
